(19) United States
(12) Patent Application Publication
(10) Pub. No.: US 2003/0014842 A1
(43) Pub. Date: Jan. 23, 2003

(54) Ergonomic high volume evacuator handle

(76) Inventor: Amy J. Niendorf, Boise, ID (US)

Correspondence Address: PEDERSEN & COMPANY, PLLC, P.O. BOX 2666, BOISE, ID, 83701, US

(21) Appl. No.: 10/184,800

(22) Filed: Jun. 28, 2002

Related U.S. Application Data
(60) Provisional application No. 60/302,165, filed on Jun. 28, 2001.

(51) Int. Cl. E05B 1/00

(52) U.S. Cl. 16/430

(57) ABSTRACT

Disclosed is an ergonomic handle for the high volume evacuator that is designed to reduce the incidence of fatigue-related medical conditions among dental assistants. The handle comprises a hollow tube composed of a rigid material that allows the suction to flow through the interior, a valve that allows the suction to be turned on and off, and a soft, non-latex rubber grip specifically shaped to match the natural curvature of the hand for a variety of grasps. The grip has a bulbous mid-section, and two recessed areas, one on each side of the bulbous mid-section. In addition, both the proximal and distal ends of the grip are flared. Preferably, the design will be compatible with existing technology to make its incorporation into modern dental offices simple and inexpensive. The device may maximize comfort and minimize the stresses encountered by dental assistants in a normal working day, specifically in the area of the hand.

### DESCRIPTION

This application claims priority of my prior, co-pending provisional patent application, Serial 60/302,165, filed on Jun. 28, 2001, entitled “ERGONOMIC HIGH VOLUME EVACUATOR HANDLE,” which is incorporated herein by reference.

### BACKGROUND OF THE INVENTION

1. Field of the Invention

This invention relates to the physical health of dental health professionals. More specifically, this invention is an ergonomic grip design for a high volume evacuator that may reduce the risk of fatigue related conditions, such as carpal tunnel syndrome, that is associated with long-duration chair-side assistance.

2. Related Art

Painful medical conditions caused by fatigue may result in a significant loss of productivity within the workplace or prematurely end the careers of employees. One common fatigue related injury among dental assistants, specific to the hand and wrist, is carpal tunnel syndrome. Complications such as carpal tunnel syndrome may be the result of repeated or prolonged exposure to stressful postures or actions. If the body and its sections are positioned correctly, from a biomechanical perspective, these complications may be avoided.

In the past, few attempts have been made to improve the apparatus used daily by dental assistants, specifically the high volume evacuator (HVE). One existing design involves an alteration to the straight-line suction path used presently. In this design the handle forms a near right angle with the disposable suction tip and the valve is operated with the thumb rather than the small and ring fingers. Another current product consists of a short slide-on grip composed of latex-free silicone rubber and is shaped similarly to a golf club grip, simply thicker in the middle than on the ends. Still, there is a need for an ergonomically designed HVE handle that can be simply and inexpensively integrated into common practice.

### SUMMARY OF THE INVENTION

The invention comprises a modified handle for the high volume evacuator commonly used in dental offices. This handle more closely models the contour of the hand. The objective of this design is to reduce the incidence of carpal tunnel syndrome and other fatigue related conditions among dental health professionals. Use of the device may allow these professionals to provide chair side assistance for long periods of time without pain. Another objective of this invention is to make the integration of this technology into modem dental offices simple and inexpensive by conforming to existing design specifications as much as possible.

This device may consist of a few simple components. The internal aspect of the handle comprises a channel that provides the link between the patient and the evacuation source. This channel is typically comprised of a metal tube that is fitted with a rotating ball valve. The rearward portion of the metal tube, or pipe, includes a set of threads or ridges that allow the evacuator hose to be attached. At the front of this pipe, a disposable O-ring is attached internally. This O-ring ensures a tightly sealed connection between the handle and the removable suction tips that are used presently with high volume evacuators. The forward section of the handle includes a rotating-ball valve. This preferably consists of a sphere with a center bore that is attached to a plastic lever by a short metal stem. Movement of the lever rotates the ball within the tube to allow, or prevent, suction through the center-bore.

The metal interior of the handle is surrounded by a soft, autoclavable rubber grip. This grip produces the contoured shape of the invention and provides insulation from the metal parts. The rubber grip has a bulbous mid-section that is tapered towards both ends. The tapered forward section offers a suitable gripping surface for the pinkie finger, and the tapered rearward portion allows the thumb and forefinger to grip comfortably. The swollen middle section is designed to fit the palm of the hand or the insides of the thumb and fingers more naturally. After the taper at both ends of the bulbous mid-section are flared distal and proximal end sections. There flared ends provide rest/stop places for fingers or the thumb, depending on the manner in which the handle is held by the user. The rubber grip is removable for autoclavability, but can also be cleaned with disinfectant. A disposable plastic sleeve may be manufactured for sterility purposes.

### BRIEF DESCRIPTION OF THE DRAWINGS

FIG. 1 is a side, schematic view of one embodiment of the ergonomic high volume evacuator handle of the present invention.

FIG. 2 is a side, schematic view of the internal components of the embodiment shown in FIG. 1, indicating the suction path and the direction of flow.

FIG. 3 is another side, schematic view of the embodiment of FIG. 1, showing some dimensions of the basic form of the grip.

FIG. 4 is a detail, schematic internal view of the valve used in the present invention.

FIG. 5 is a detail, schematic drawing of the rotating ball valve shown in FIG. 4.

FIG. 6 is a detail, schematic top view of the valve pictured in FIG. 4, showing the angles of rotation for the plastic lever required to open and close the valve.

FIG. 7 is an internal view of the valve, showing the placement of the O-ring that seals the connection between the handle and the disposable suction tip.

FIG. 8 is an illustration of one common grasp of the handle of the present invention used by dental assistants.

FIG. 9 is an illustration of another common grasp of the handle of the present invention used by dental assistants.

### DETAILED DESCRIPTION OF THE INVENTION

Referring to the Figures, there are depicted several views of the invented ergonomic handle 100 for the high volume evacuator commonly used in dental offices. This device will preferably be used by professional dental assistants to provide a gripping surface that readily conforms to the contours of the hand. This will increase comfort and reduce the incidence of carpal tunnel syndrome and other fatigue related conditions.

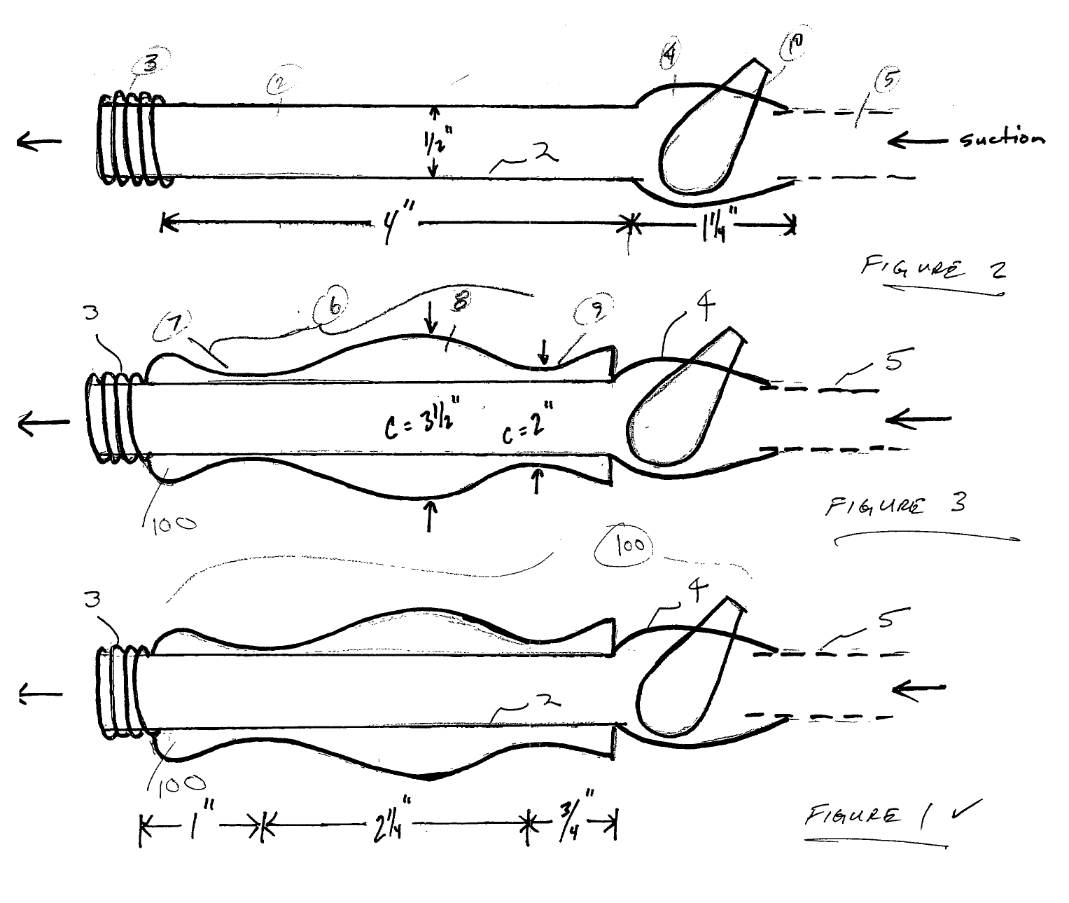

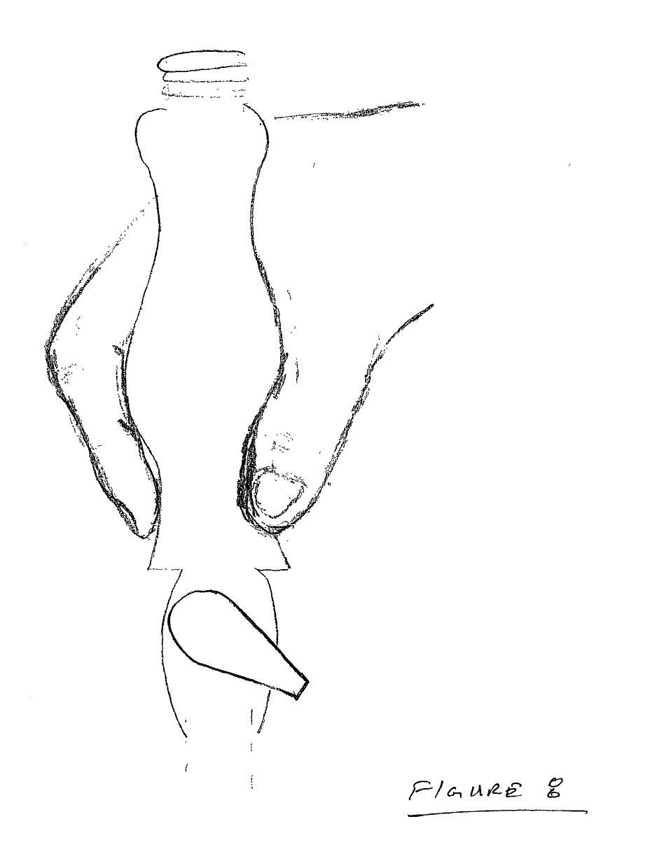

The preferred embodiment of the ergonomic design for a high volume evacuator handle 100 is shown in FIGS. 1 and 2. The handle 100 comprises a soft shell or wrap which surrounds a metal tube 2, or pipe, that is approximately ½ inch in diameter and preferably about 4 inches long. The metal tube 2 is fitted with a set of threads or ridges 3 at the rear (proximal) end and a valve 4 at the front (distal) end. The threads 3 are used to connect the metal tube 2 to the evacuator hose, which is not shown in the figures. The valve 4 shown in detail in FIG. 4 houses the rotating ball valve 10 that is shown in detail in FIG. 5, and provides the functional link between the metal tube 2 within handle 100 and the disposable suction tip 5.

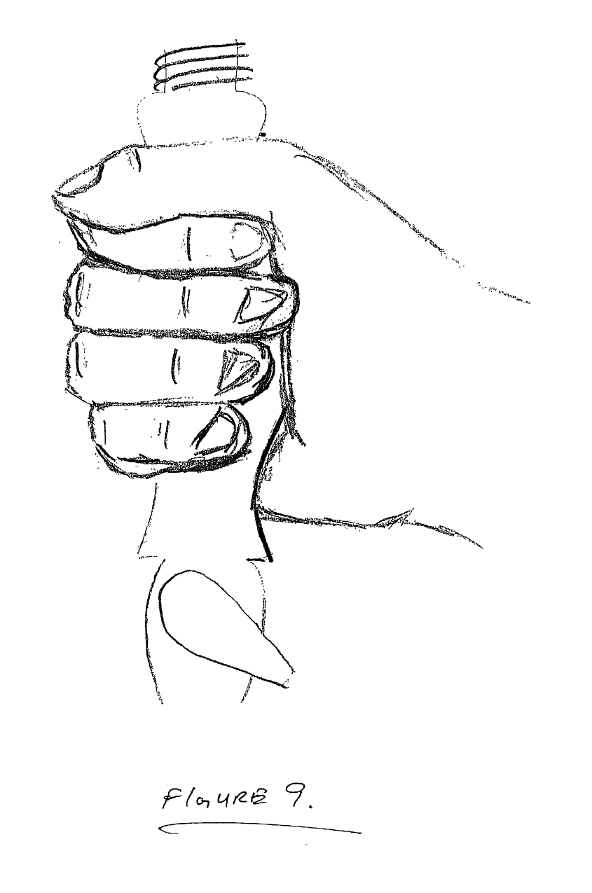

The rotating ball valve 10 comprises a metal sphere 12 with a center bore that attaches to a plastic lever 11 by a short metal stem 13. The plastic lever forms a U-shape around the valve seat 4, and is connected to the sphere 12 at the ends by two short connections 13, as shown in FIG. 5. The plastic lever 11 rotates from approximately 45 degrees to 135 degrees with respect to the axis of the metal tube 2 as shown in FIG. 6. The lever is typically rotated in operation by using the small and ring fingers in a sweeping motion. The valve 10 is in the ‘on’ position when the plastic lever 11 is at an angle of 135 degrees. In this position, suction flows through the handle 1 in the direction indicated in FIGS. 1, 2, and 3. At the distal end, the interior of the valve 4 contains a replaceable, rubber O-ring 14 as shown in FIG. 7. The O-ring 14 ensures the necessary seal between the metal tube 2 within handle 100 and the disposable suction tip 5 at the point of attachment, as shown in FIG. 7.

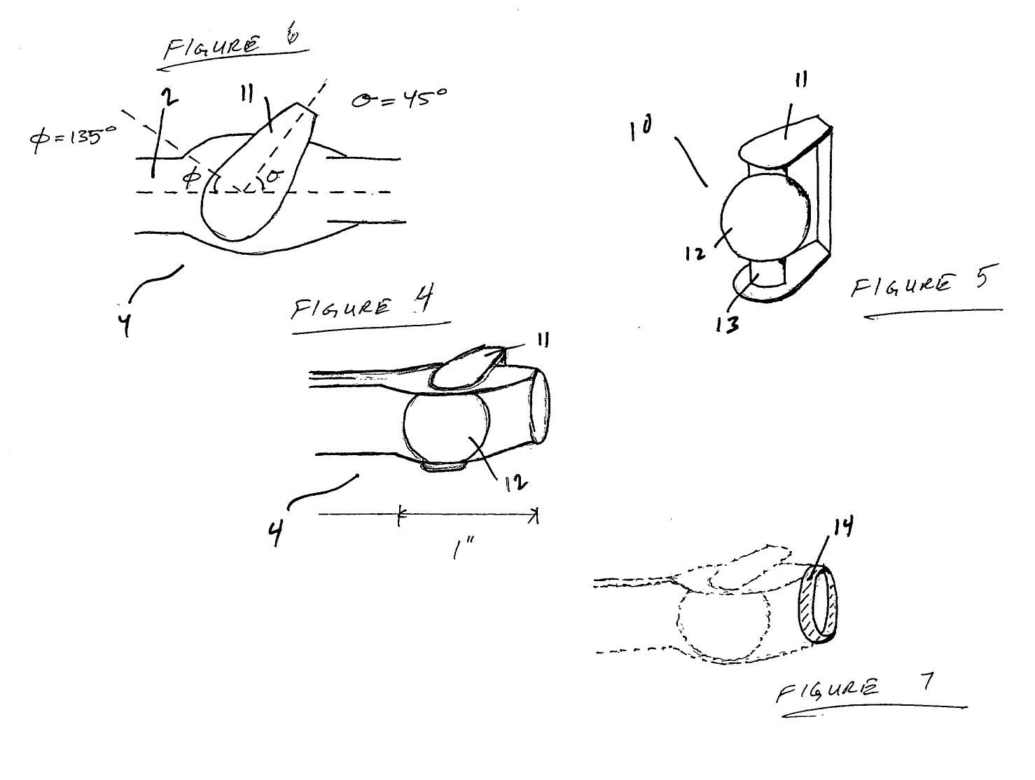

A soft, rubber grip 6 of handle 100 surrounds the metal tube 2 between the valve 4 and the set of threads or ridges 3. The grip 6 comprises a bulbous mid-section 8 and tapered sections towards both the rear (proximal) end 7 and the front (distal) end 9, as shown in FIG. 3. The grip design preferably includes flared ends to prevent slippage in the hand and create the useful recessed areas, tapered sections 7 and 9. The grip is preferably about 3.5 inches in circumference at its widest point, typically the bulbous mid-section 8 and preferably about 2 inches in circumference at its narrowest point(s), typically the tapered sections 7 and 9. The flared ends are typically more in circumference than the tapered sections, and less in circumference than the bulbous mid-section. These dimensions, and other preferred grip specifications are shown in FIGS. 1, 2 and 3.

The rubber grip 6 is preferably a soft, removable wrap that can be fastened around the metal tube 2 by any one of a number of simple mechanisms. It may, however, alternatively comprise a flexible, hollow cylinder that may be slid off over the threads or ridges 3 or over the distal end after the valve 4 is removed. The grip 6 may be cleaned in place with disinfectant, but it may also be removed for autoclavability.

The ergonomic handle 100 provides a comfortable gripping surface for a variety of grasps, two of which are shown in FIGS. 8 and 9. Using the pencil grip of FIG. 8, the tapered section 7 nearest the threads or ridges 3 in connection with the flared proximal end allows the thumb and index finger to wrap comfortably around the handle 100. The tapered section 9 nearest the valve 4 in conjunction with the flared distal end, provides a supportive groove for the thumb, index and middle distal phalanxes, or fingertips, as shown in FIG. 8. For this hold, the bulbous mid-section 8 matches the natural curvature of the thumb and index fingers to provide a comfortable and stable grasp.

Using the stab grip illustrated in FIG. 9, the ergonomic handle 1 utilizes contact with most all of the hand's interior surface to provide a firm, comfortable hold. The narrow proximal section 7 provides a comfortable gripping surface for the thumb and index finger. The distal grasp the handle powerfully with only the fingertips and prevents uncomfortable overlap between the fingers and the hand, as shown in FIG. 9.

Although this invention has been described above with reference to particular means, materials and embodiments, it is to be understood that the invention is not limited to these disclosed particulars, but extends instead to all equivalents within the scope of the following claims.

I claim:

1. An ergonomic handle for a high volume evacuator, comprising:
a grip surrounding an evacuator tube, the grip comprising:
a bulbous mid-section, said bulbous mid-section being tapered toward the ends of said grip;
a tapered forward (distal) section, and a tapered rearward (proximal) section, the circumferences of the tapered sections being substantially less than the circumference of the bulbous mid-section; and
flared forward (distal) and rearward (proximal) ends, the circumference of the flared ends being substantially more than the circumference of the tapered sections.

2. The handle of claim 1 wherein the grip is a wrap around the evacuator tube.

3. The handle of claim 1 wherein the grip is a cylinder which slips over evacuator tube.
